(19) United States
(12) Patent Application Publication
(10) Pub. No.: US 2004/0101251 A1
(43) Pub. Date: May 27, 2004

(54) Plastic optical connector

(75) Inventors: Thomas F. Rahrig, Woodhaven, MI (US); Adam W. Kennedy, Gladstone, OR (US)

Correspondence Address: HARRINGTON & SMITH, LLP, 4 RESEARCH DRIVE, SHELTON, CT, 06484-6212, US

(73) Assignee: FCI Americas Technology, Inc.

(21) Appl. No.: 10/306,964

(22) Filed: Nov. 27, 2002

(51) Int. Cl. G02B 6/38

(52) U.S. Cl. 385/59

(57) ABSTRACT

A multichannel fiber connector including a pair of mating connector parts, each including a body, each mating connector part including an optical fiber coupling element for each respective channel. The optical fiber coupling element having an outer section and an inner section. The coupling element is positioned on a first fiber receiving side having a first thread section and the coupling element on a second fiber receiving side having a second threaded section. The first and second threaded sections are directly in contact with and biting into the first and second fibers when the fibers are positioned in the respective optical coupling element. The connector further includes a latching assembly comprising a resilient locking arm on one connector part and a locking catch on the other connector part. The locking arm is adapted to engage the locking catch when the connector parts are mated and secure the parts together.

### BACKGROUND OF THE INVENTION

1. Field of the Invention

The present invention relates to optical connectors and, more particularly, to a two-way plastic optical fiber connector.

2. Brief Description of Related Developments

U.S. Pat. No. 6,024,498 discloses an optical fiber connector assembly. The connector is a single molded plastic part with a passage extending axially therethrough. The passage has a fiber holding means. A cantilever latch is mounted on the front end of the plug. When the plug is inserted into the adapter, the cantilever latch arm is depressed until a locking tab passes a shoulder in the bore.

U.S. Pat. No. 6,277,719 discloses a plastic optical fiber connector that allows a pair of plug, connectors to bring the end faces of the optical fibers in an opposed orientation. The connector comprises an adapter holder into which identical plug connectors are removably inserted. A lock arm 43 and support post define a T-shape. The lock arm on the plug connector housing has a lock hook that can engage a lock lever hole on the adapter.

### SUMMARY OF THE INVENTION

In accordance with one aspect of the present invention, a multichannel fiber connector is provided including a pair of mating connector parts, each including a body; each mating connector part including an optical fiber coupling element for each respective channel. The optical fiber coupling element has an outer section and an inner section. The coupling element is positioned on a first fiber receiving side having a first thread section and the coupling element on a second fiber receiving side having a second threaded section. The first and second threaded sections are directly in contact with and biting into the first and second fibers when the fibers are positioned in the respective optical coupling element. The connector further includes a latching assembly comprising a resilient locking arm on one connector part and a locking catch on the other connector part. The locking arm is adapted to engage the locking catch when the connector parts are mated and secure the parts together.

In accordance with another aspect of the present invention, a plastic optical fiber connector assembly is provided comprising a plug assembly having at least one ferrule assembly integrated therein adapted to retain and position an end of a first fiber optic cable; and a socket assembly having at least one ferrule assembly integrated therein adapted to retain and position an end of a second fiber optic cable. When the plug assembly and socket assembly are mated, the end of the first cable and the end of the second cable are optically aligned. The connector further comprises a connector position assurance device adapted to detect a partially connected assembly and securely latch the plug assembly and socket assembly together.

### BRIEF DESCRIPTION OF THE DRAWINGS

The foregoing aspects and other features of the present invention are explained in the following description, taken in connection with the accompanying drawings, wherein:

FIG. 1 is a perspective view of one embodiment of a optical fiber connector assembly incorporating features of the present invention.

FIG. 2 is a top plan view of one embodiment of the connector assembly illustrated in FIG. 1.

FIG. 3 is a side view of one embodiment of the connector illustrated in FIG. 1.

FIG. 4 is a cross-sectional view of the connector illustrated in FIG. 2 taken along the line B-B.

FIG. 5 is a cross-sectional view of the connector assembly illustrated in FIG. 3 taken along the line CAV1-CAV1.

FIG. 6 is an enlarged partial view of the cross-sectional area illustrated in FIG. 5.

FIG. 7 is a perspective view of a socket assembly in one embodiment of a connector assembly incorporating features of the present invention.

FIG. 8 is an end view of the socket assembly illustrated in FIG. 7.

FIG. 9 is a cross-sectional view of the socket assembly of FIG. 8 taken along the line B6-B6.

FIG. 10 is a cross-sectional view of the socket assembly of FIG. 8 taken along the line A6-A6.

FIG. 11 is a perspective view of a plug assembly in one embodiment of a connector assembly incorporating features of the present invention.

FIG. 12 is an end view of the plug assembly shown in FIG. 11.

FIG. 13 is a cross-sectional view of the plug assembly of FIG. 12 taken along the line B3-B3.

FIG. 14 is a cross-sectional view of the plug assembly of FIG. 12 taken along the line A3-A3.

FIG. 15 is a partial perspective view of the outer crimp areas on the socket portion of the connector assembly shown in FIG. 1.

FIG. 16 is a partial perspective view of the crimp areas on the plug portion of the connector assembly shown in FIG. 1.

FIG. 17 is a perspective view of one embodiment of a connector assembly incorporating features of the present invention.

FIGS. 18A and 18B are a top plan view and a side elevational view of the connector assembly shown in FIG. 17.

FIG. 19 is a perspective view of one embodiment of a socket assembly for the connector assembly shown in FIG. 17.

FIG. 20 is an end view of a socket assembly shown in FIG. 17.

FIG. 21 is a top plan view of one embodiment of the socket assembly illustrated in FIG. 17.

FIG. 22 is a perspective view of one embodiment of a plug assembly for a connector incorporating features of the present invention.

FIG. 23 is an end view of one embodiment of a plug assembly incorporating features of the present invention.

FIG. 24 is a top view of the plug assembly shown in FIG. 22.

FIG. 25 is a side view of the plug assembly shown in FIG. 22.

FIG. 26 is a partial cross-sectional view of the plug assembly of FIG. 23 taken along the line C12-C12.

FIG. 27 is a diagrammatic view of a layout of the terminal cavities and the polymer optical fiber (POF) of the connector shown in FIG. 17.

FIGS. 28 and 29 are diagrammatic views of alternate embodiments of the layout shown in FIG. 27.

### DETAILED DESCRIPTION OF THE PREFERRED EMBODIMENT(S)

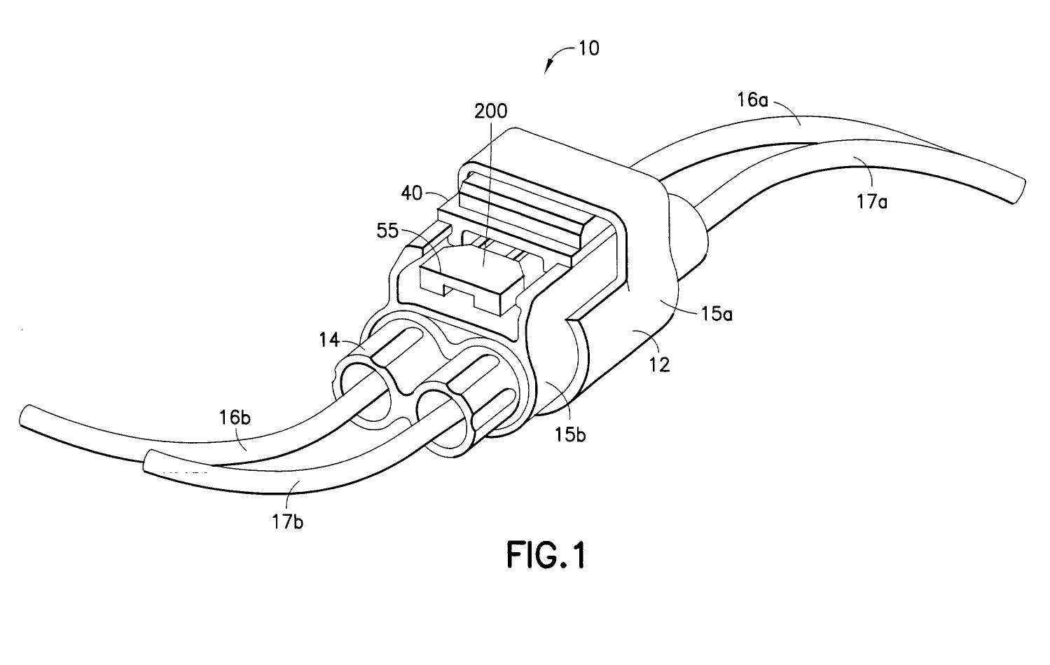

Referring to FIG. 1, there is shown a perspective view of a connector assembly 10 incorporating features of the present invention. Although the present invention will be described with reference to the embodiment shown in the drawings, it should be understood that the present invention can be embodied in many alternate forms of embodiments. In addition, any suitable size, shape or type of elements or materials could be used.

As shown in FIG. 1, the connector assembly 10 generally comprises a plastic optical fiber connector showing a mated pair, female socket assembly 12 and male plug assembly 14. Plastic optical fibers 16a, 16b, 17a, 17b extend out of the rear connector half. Fibers 16a, 16b and 17a, 17b form fiber pairs. Although a two-way connector is shown in FIG. 1, in alternate embodiments the connector assembly 10 could comprise other than a two-way connector, such as for example, a six-way connector. The connector 10 is generally adapted to bring at least one optical fiber pair face to face in order to couple the fibers together. The optical fiber or conductor referred to herein can also be called a plastic or polymer optical fiber (“POF”).

FIG. 1 illustrates a mated connector pair with plastic optical fiber pairs 16a and 16b, and 17a and 17b. The connector 10 generally comprises two connector parts, socket (female) assembly 12 and plug (male) assembly 14, shaped for cooperation in order to align and center each optical fiber pairs when the socket assembly 12 and plug assembly 14 are mated.

In the embodiment illustrated in FIG. 1, the socket assembly 12 and a plug assembly 14 each having a housing 15a and 15b, respectively, preferably formed of molded plastic. In alternate embodiments the housings 15a and 15b could be any suitable type or material for forming an optical fiber connector.

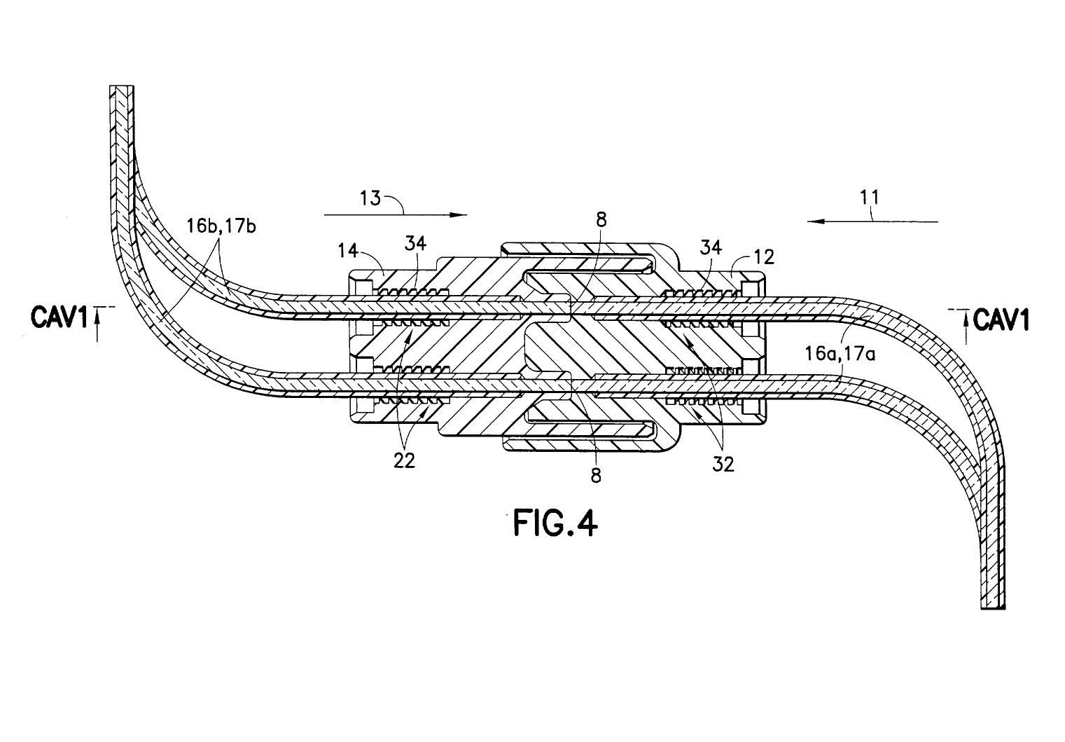

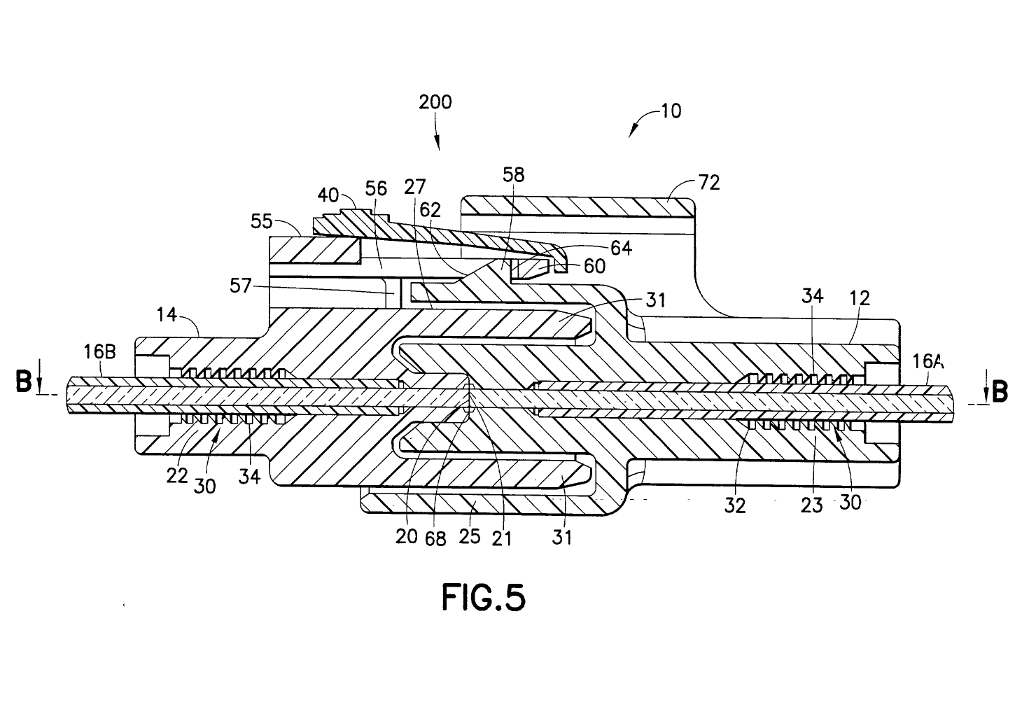

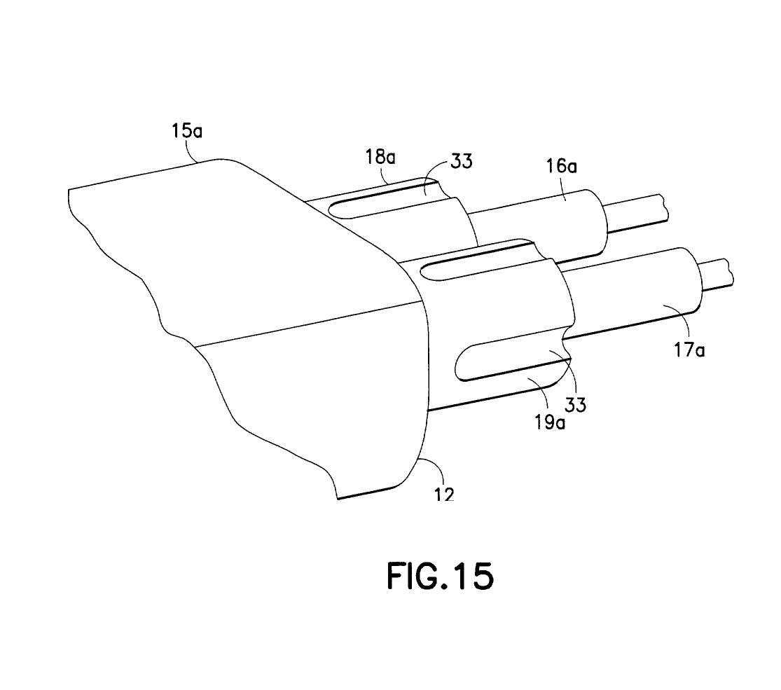

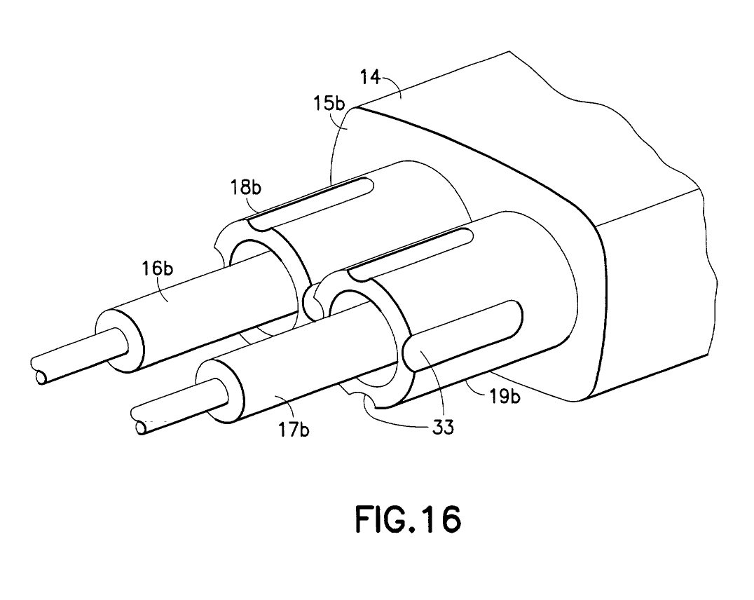

Referring to FIGS. 4 and 5, the optical fibers are generally retained in each housing by integrated ferrules 22 and 32. Each integrated ferrule is molded into its respective housing. Each integrated ferrule 22, 32 generally comprises a threaded crimp plug 30, the details of which will be described herein. It is a feature of the present invention to crimp the optical fiber pair in its respective housing, 15a, 15b. As shown in FIGS. 15 and 16, a portion of the housing extends laterally to allow the fiber to be crimped therein. In prior systems, the optical fibers had to be first crimped within a ferrule and the ferrule was then inserted into and secured within the respective connector half.

Also shown in FIG. 1 is a connector position assurance (CPA) device 40 on a top surface of the connector assembly 10. The connector position assurance device 40 is attached to male connector housing 15b becoming an integral part of male connector assembly 14 and latch assembly 200. Latch assembly 200 is adapted to secure the socket and plug assemblies 12 and 14 of the connector assembly 10 together.

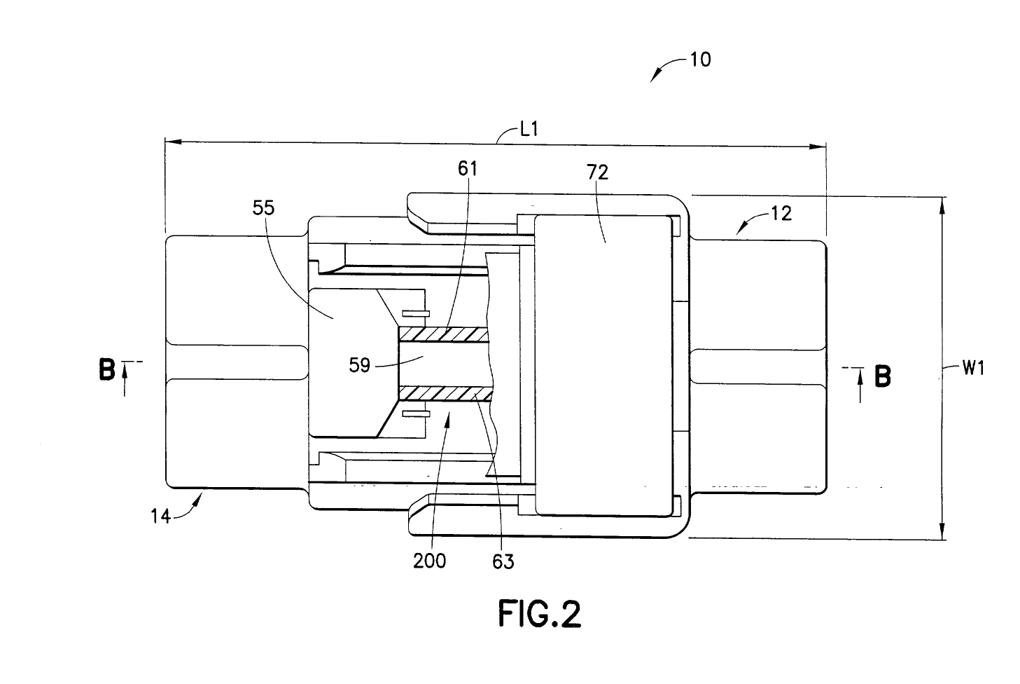

Referring to FIG. 2, the latch assembly 200 is generally positioned on a top surface of the connector assembly 10. The latch assembly 200 is adapted to lock the members 12, 14 together when the two halves are coupled. In order to release the mating portion of the connector 10 from the locked position, the connector position assurance device 40 is pulled back and, a rear member 55 of the latch assembly 200 is depressed. The latching assembly 200 can generally be visually or mechanically inspected to ensure that the mating halves 12, 14 of the connector assembly 10 are properly mated.

In a “locked” position, referring to FIGS. 2 and 5, the rear member 55 of the assembly 200 is substantially horizontal. If the rear member 55 is skewed or on an angle relative to a horizontal plane, it is an indication that the connector halves 12, 14 are not properly mated and the connector position assurance device 40 cannot be pushed forward. It is a feature of the present invention to securely latch the mating halves 12, 14 together while maintaining the required tolerance between the optical reference planes.

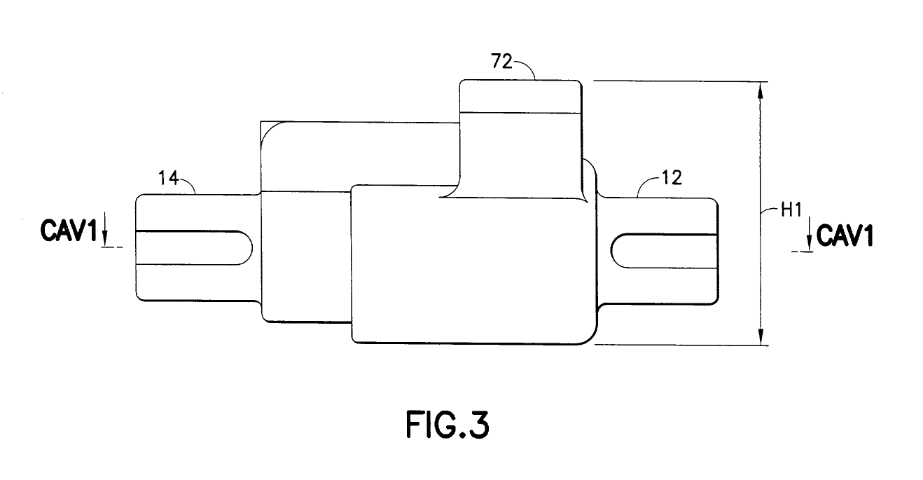

FIGS. 2 and 3 illustrate the overall dimensions of the connector assembly 10. In one embodiment, as shown in FIG. 2, an overall length L1 of the connector assembly 10 can be approximately 37.8 mm. The width W1 of the connector 10 can be approximately 18.5 mm. The dimensions referred to herein are merely examples, and any suitable dimensions can be used.

FIG. 4 illustrates a cross-sectional view of the mated connector assembly 10 taken along the line CAV1-CAV1. FIG. 4 illustrates optical fiber pairs 16a, 16b and 17a, 17b inserted and crimped within the respective integrated ferrules 22, 32. Both cables for each connector half are shown with the outer jacket in place up to all but the last few millimeters. Both cables in each connector half 12, 14 are retained within the integrated ferrules 22, 32. FIG. 4 also illustrates the cable insertion direction 11, 13 for each connector half 12, 14 respectively.

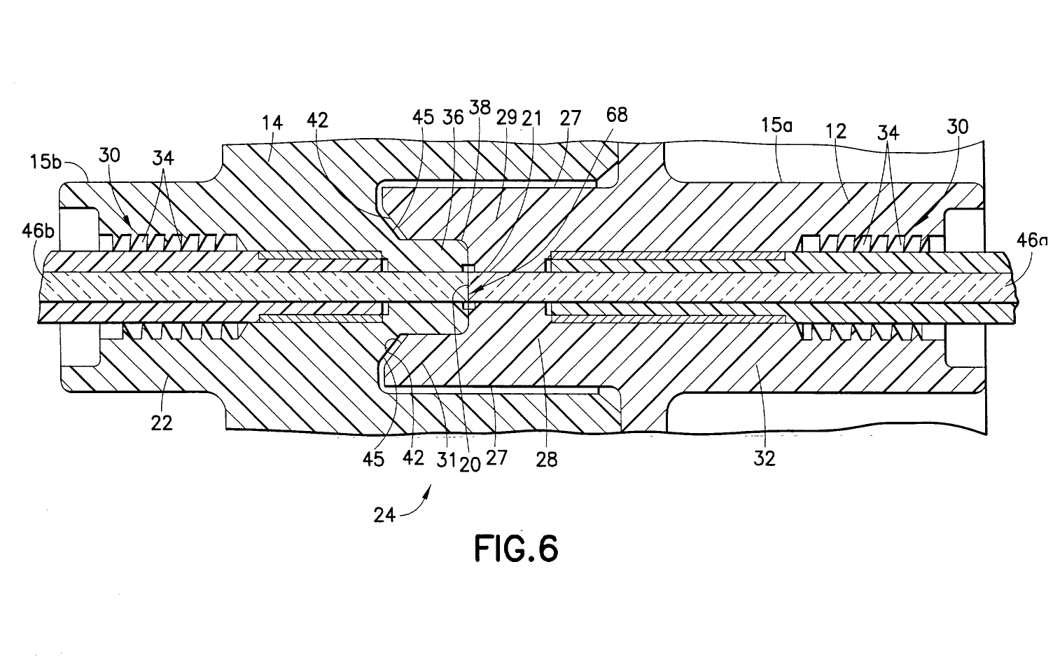

Since the connector elements are primarily for optical connection, the connector elements are designed to have a perpendicular optical reference plane defined at the contact plane 8 of the fiber tips. The perpendicular optical reference plane limits the optical coupling losses. Referring to FIG. 5, the optical connection between the socket 12 and plug 14 is generally based on alignment and guiding structures comprising complementary comeral shapes. For example, referring to FIG. 6, an end 28 of the tip part 29 of the socket element is adapted to received a fiber 46a. A foot part 31 of the tip 29 together with a bottom part of the recess of the plug element 14 receives the tip 29. It is a feature of the present invention to align, guide and lock the optical fiber structures into a position that limits the optical coupling losses.

FIG. 5 is a cross-sectional view of the mated connector assembly 10 of FIG. 3 taken along the line CAV1-CAV1. As shown, the optical fiber cable pair 16a, 16b is inserted and crimped within integrated ferrules 22, 32, respectively. The latch assembly 200 is shown in the “locked” or “mated” position. Each respective fiber tip 20, 21 is closely aligned along a perpendicular reference plane 68. FIG. 6 is an partial cross sectional view of FIG. 5 illustrating more clearly the optical fiber alignment features of the connector assembly 10.

FIG. 6 illustrates the coupling 24 of the socket assembly 12 and plug assembly 14 as a section through the connector housings 15a and 15b. As shown in FIG. 6, there are two cable ends 20, 21, of a cable pair 46a, 46b, the ends of which have been brought together coaxially. A hot plate finish or a precision cut finish can be used on each end 20, 21. In alternate embodiments, the cable ends 20, 21 can be brought together in any suitable manner for coupling optical fibers. As shown in FIG. 6, the outer jacket of the cable pairs 46a and 46b are generally stripped from the end of the cable.

As shown in FIG. 6, the plug assembly 14 includes a barrel shaped member or tip 36 that is received in a complementary barrel receiving member 38. An alignment foot or member 31 of the socket assembly 12 is received in a complementary receiving area 27 of the plug assembly 14. Two alignment members 31 are shown, one on either side of the barrel receiving member 38, and are received into the complimentary receiving areas 27. As will be discussed herein, the alignment members 31 and receiving areas 27, form the alignment and guiding structures to align the optical ends 20, 21 to form the optical connection.

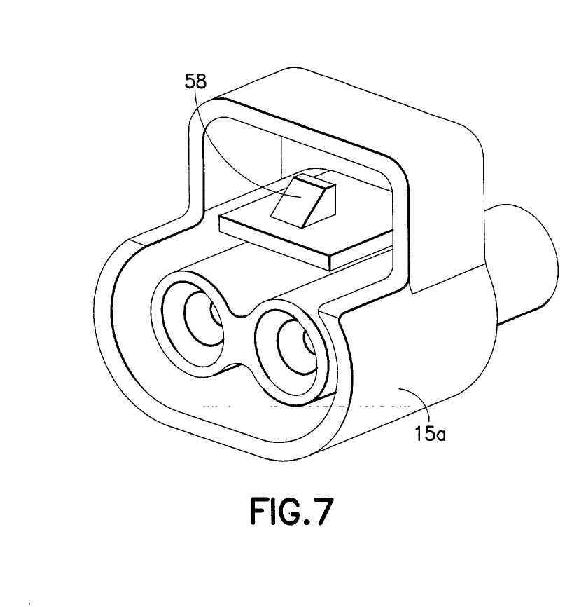

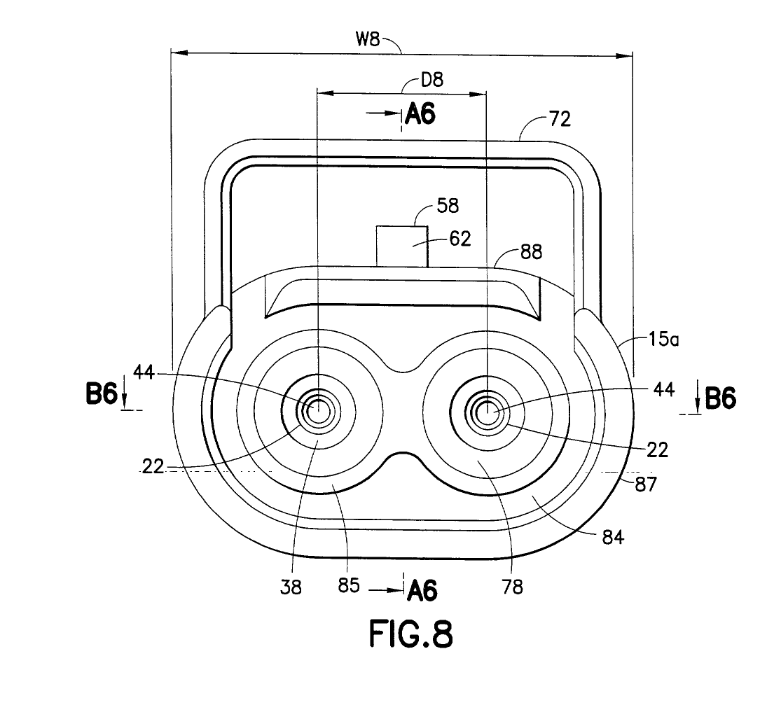

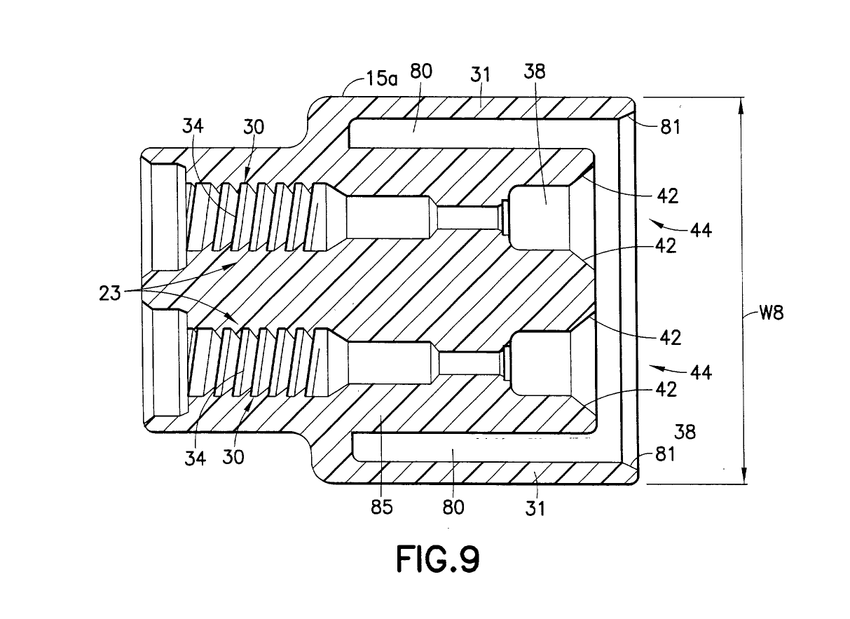

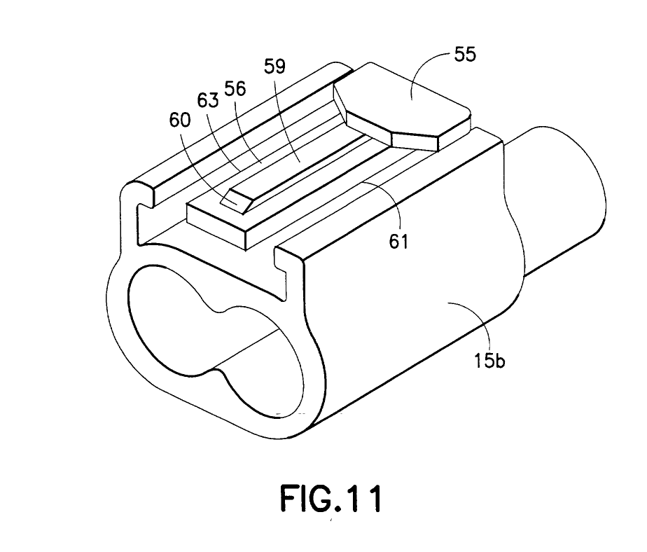

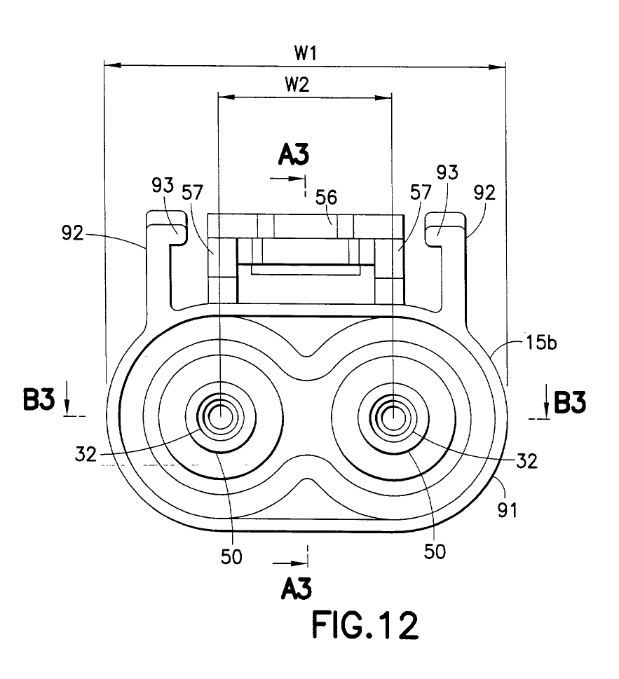

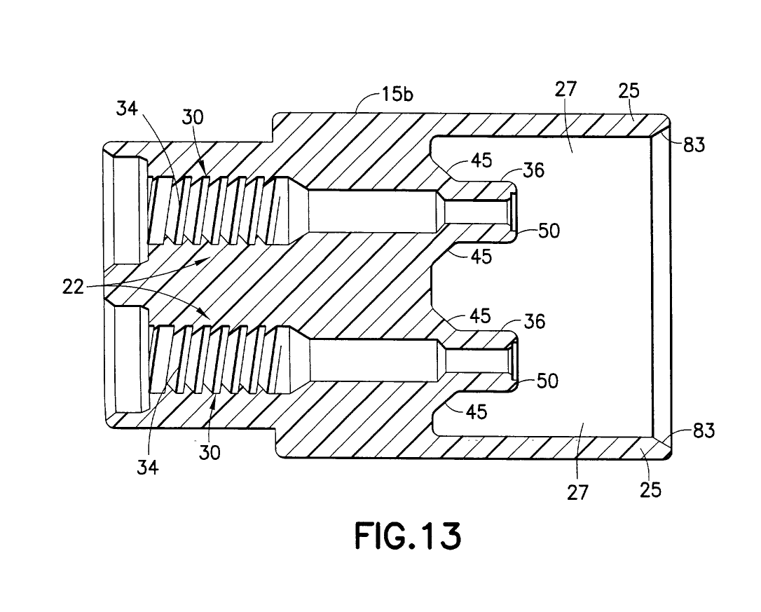

FIG. 7 is a perspective view of one embodiment of socket housing 15a while FIG. 11 is a perspective of one embodiment of plug housing 15b. FIG. 9 is a cross-sectional view of the socket 15a taken along the line B6-B6 of FIG. 8 rotated 90° counter clockwise, while FIG. 13 is a cross-sectional view of the plug housing 15b taken along the line B3-B3 of FIG. 12 rotated 90° counter clockwise.

FIG. 8 is an end view of the socket housing 15a shown in FIG. 7. As shown therein, the socket 15a generally comprises a first outer housing member 87, a second outer housing member 88 and an interior member 85. A cover 72 generally extends from the first housing member 87 over the member 88 and locking catch 58. The locking catch 58 is positioned or molded on the second housing member 88. A gap or void 84 is formed between the first outer housing member 87 and the interior member 85, and second housing member 88. The complimentary housing member 91 of the plug 15b, shown in FIG. 12, is received in the void 84 when the connector assemblies 12, 14 or housings 15a, 15b are mated. The side members 92 of the housing member 91 shown in FIG. 12 guide the housing member 88 of FIG. 8 into position. The ends 93 of side members 92 can be curved inwardly to assist in guiding and aligning the two assemblies 12, 14 or housings 15a, 15b when they are mated.

Referring to FIG. 8, in one embodiment, the distance D8 between the center lines of each barrel opening 38 is approximately 7.0 mm. An overall width W8 of the socket assembly 12 or connector 15a can be approximately 18.5 mm, also shown in FIG. 9.

FIGS. 9 and 13, generally illustrate the optical fiber cable alignment features in the ends of each plug housing 15a and socket housing 15b. An outer diameter of the entryway 44 to the barrel receiving member 38 is generally larger than rest of the barrel receiving member. As shown in FIG. 9, each opening or entry way 44 to the barrel receiving member 38 includes at least one chamfered edge 42 that guides each barrel member 36 of FIG. 13 into an aligned position in the barrel receiving member 38.

As shown in more detail in FIG. 13, each plug housing 15b includes one or more barrel shaped members 36. Each barrel member 36 can include a chamfered edge 50 at its forward corners to aid in guiding the barrel member 36 into an aligned position in the barrel receiving member 38. The end of the optical fiber cable is received into a respective barrel 36. The barrel members 36 are adapted to be received in the complimentary barrel receiving members 38 in the socket housing 15a shown in FIG. 9. The barrel member 36 also includes a chamfered edge 45 which serves as a shoulder stop against chamfered edge 42 of socket housing 15a when the plug housing 15b is inserted into socket assembly. Referring to FIG. 6, the shoulder stop 45 abuts a complimentary chamfered edge or shoulder stop 42 when the connector halves are mated.

Also shown in FIG. 9 is each opening or area 80 into which the portion 25 of the plug housing 15b is received when the assemblies 12, 14 are mated. The outer edges 31 of the socket housing 15a include a chamfered edge 81 to help guide the member 25 and align the assemblies during mating. The portion 25 of the plug housing 15b can also include chamfered edges 83 to guide the assembly 14 over the portion 85 of the socket assembly 12.

Referring to FIGS. 9 and 13 each housing 15a, 15b can include a threaded crimp plug (“TCP”) 30 for securing a respective optical fiber cable therein. In one embodiment, the threaded crimp plug 30 comprises an integrated ferrule such that described in U.S. patent application Ser. No. 6,244,752 B1, the disclosure of which is incorporated herein by reference in its entirety. As shown in FIGS. 9 and 13 each threaded crimp plug 30 generally include a series of, internal threads 34 that act as a crimp to deform and/or pierce the cable sheath of the fiber optic cable inserted into the plug during crimping.

The threads 34 inside of the threaded crimp plugs 30 are generally used to retain and correctly position the cable within each respective ferrule 22, 32. During the crimping process the threads 34 are forced into the outer jacket of the optical fiber cable (also referred to as “biting”) in evenly spaced areas around the outer ferrule. The depth of the threads 34 in each plug 30 is generally sufficient to allow the material of the cable sheath to escape away from the plastic fiber in order to prevent damaging pressure from being exerted on the fiber.

Referring to FIGS. 15 and 16, each connector assembly housing 15a and 15b, includes barrel shaped members 18a, 18b, 19a and 19b, which house the integrated ferrules. When a cable end is properly positioned into a respective ferrule, the outside of the barrel member, for example 19a in FIG. 15, can be crimped in areas 33 to secure the cable 17a therein. As shown in FIGS. 15 and 16, a three-place crimp is used, although any suitable number of crimp areas 33 can be used. It is a feature of the present invention to crimp the fiber optic cable in the integrated ferrule of each connector assembly 12, 14.

The latching assembly 200 shown in FIG. 1 is adapted to securely couple the socket assembly 12 and plug assembly 14 together in an aligned and mated position when the assemblies 12, 14 are coupled. The latching assembly 200 includes, as an integral part, the connector position assurance (CPA) device 40. Referring to FIG. 5, in one embodiment the latching assembly 200 generally comprises a resilient locking arm 56 on housing 15b and a locking catch 58 on housing 15a.

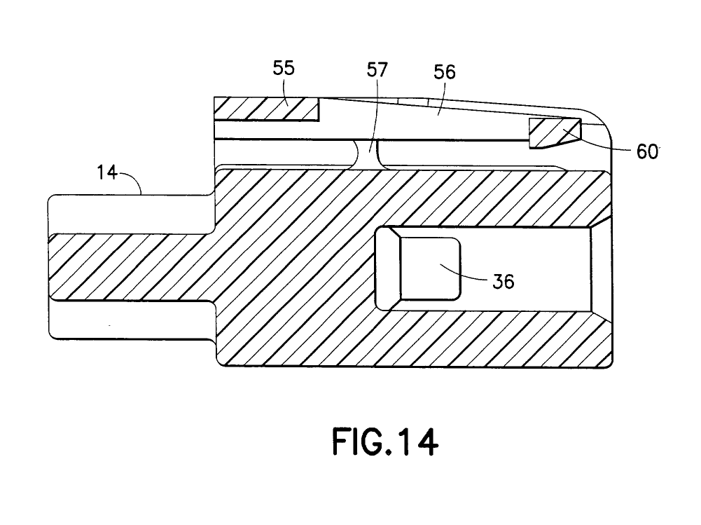

In one embodiment as shown in FIG. 14, the locking arm 56 includes a web or catch end 60, a rear member 55 and a fulcrum 57. The resilient locking arm 56 generally comprises a member that projects beyond the fulcrum 57 and can resiliently pivot about the fulcrum 57. The catch end 60 of the arm 56 is generally adapted to lock in against a rear surface 64 of the locking catch 58 without the need to apply an external force to the arm 56. In one embodiment, the arm 56 and fulcrum 57 could form a cantilever structure. A downward force on the end 55 of the arm 56 will cause the catch end or web 60 of the arm 56 to move in the opposite, or an upward direction. Generally, when a downward force is applied to the end 55 of the arm 56, the catch end 60 moves away from the locking catch 58 and the socket assembly 12 or housing 15a and the plug assembly 14 or housing 15b can be released or pulled apart from the mated condition.

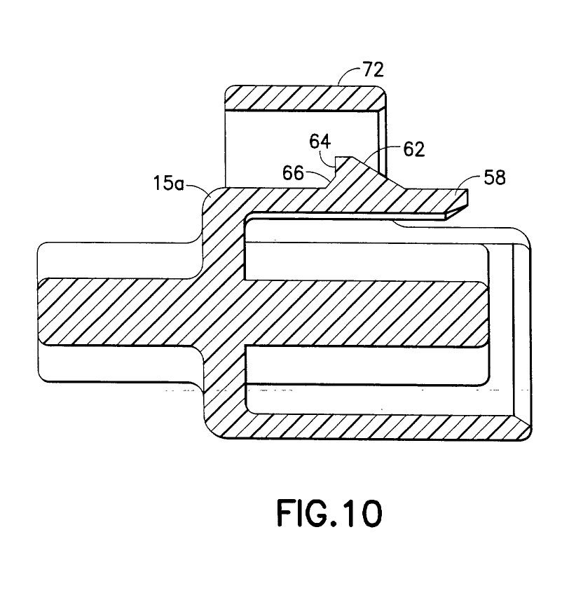

Referring to FIG. 10, in one embodiment the locking catch 58 generally comprises a front ramp 62, a rear steep surface 64 and a rear ramp 66. During mating of the plug and socket assemblies, the web 60 of the locking arm 56 rides onto the front ramp 62 of the locking catch 58 and comes into engagement with the rear steep surface 64 of the catch 58. The arm 56 is generally biased about the fulcrum 57 so that the web or end 60 of the arm 56 locks in behind and is securely positioned against the surface 64 of the catch 58 when the socket housing 15a and plug housing 15b are fully mated. A download force on end 55 is needed to release the arm 56 from the locked or mated position.

The relative positioning of the locking arm 56 allows the detection of a partially connected assembly 10. Referring to FIG. 14, in one embodiment the locking arm 56 is a movable finger that is moveable between a connector release position and a connector locking position. The locking arm 56 is normally biased in the connector locking position as shown in FIG. 5. As shown in FIG. 14, in the normally biased position, the rear member 55 is in a substantially horizontal orientation. Once locked or mated, finger pressure on the surface of end 55 of the arm 56 is required to move to the connector release position. During mating, as the web end 60 of the arm 56 rides up the ramp 62 during mating of the socket housing 15a and plug housing 15b, the end 60 and end 55 will move or be displaced relative to its normal position. The displacement of the end 55 can be visualized and indicates that socket 12 and plug 14 assemblies are not fully mated. It is a feature of the present invention to detect a partially connected assembly 10.

Referring to FIGS. 1 and 5, the latching assembly 200 can also include a cover element or member 72. The member 72 is generally part of housing 15a of the socket assembly 12. The cover element 72 is generally positioned over the locking catch 58 to prevent the accidental unlatching of the connector assembly 10.

In one embodiment referring to FIGS. 2 and 11, the arm 56 can also include an open area 59 between the end 55 and web end 60 of the arm 56. A pair of side members 61, 63 connect the ends 55 and 60. The open area is generally wide enough to accommodate the locking catch 58 shown in FIG. 7. The width of the opening 59 can be any suitable dimension to accommodate the locking catch 58.

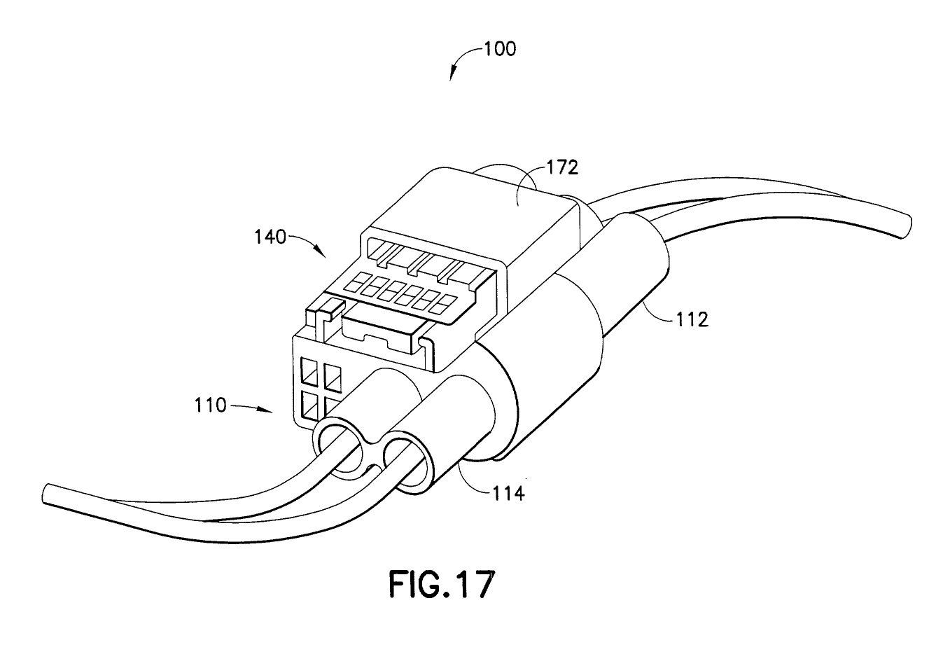

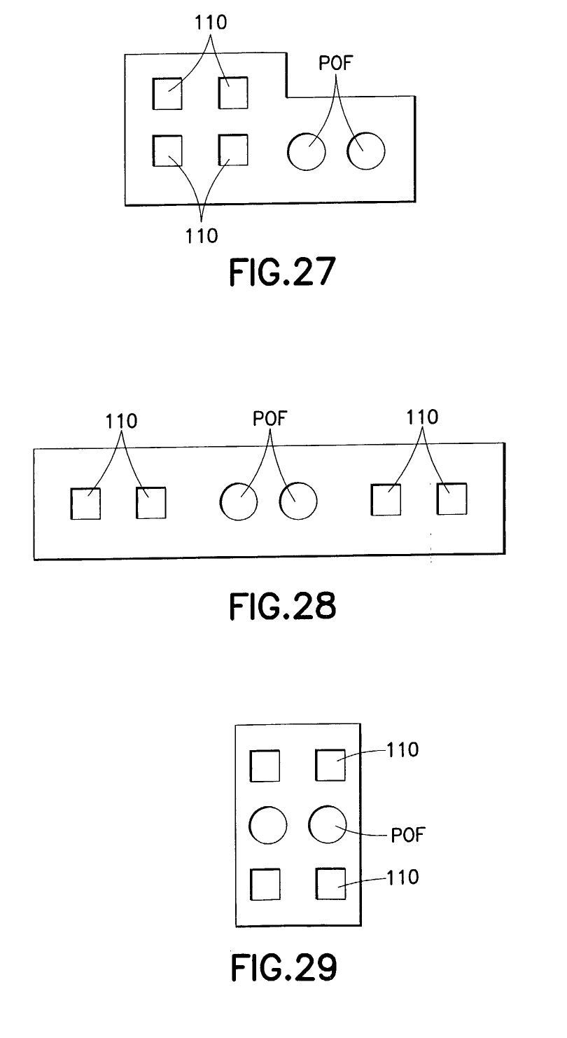

In one embodiment, referring to FIG. 17, the connector assembly 100 incorporating features of the present invention can also include a plurality of 0.64 mm terminal cavities 110 positioned or offset on a side of the connector assembly or terminal cavities 110 can be positioned with or on either side of the POF. This is further illustrated in FIGS. 27-29.

The fiber optic portions of the connector assembly 100 are substantially similar to the embodiments previously described.

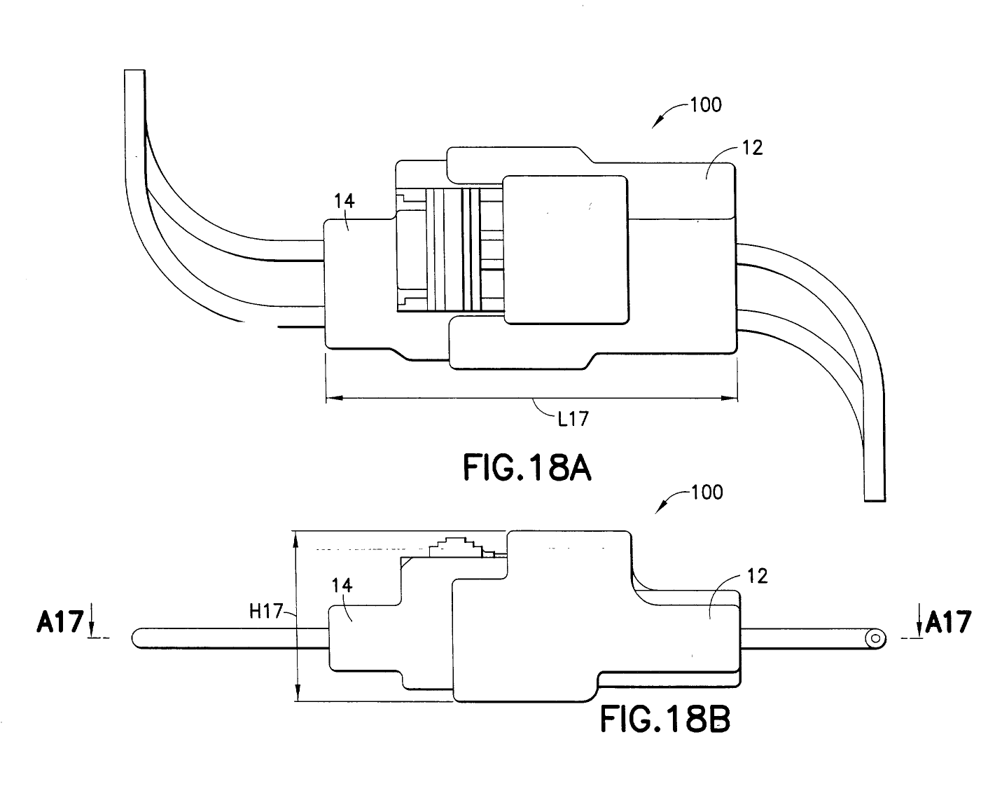

FIGS. 18A and 18B illustrates a top and side view of the connector assembly 100. The overall length L17 of the connector assembly 100 can be approximately 45.5 mm, while a height H17 can be approximately 18.2 mm.

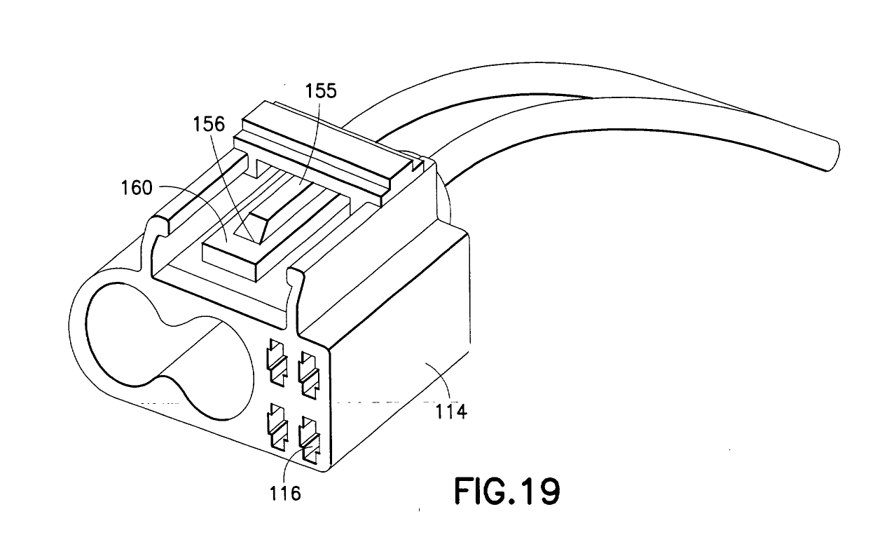

FIG. 19 is a perspective view of the plug assembly 114 of the connector 100. Openings 116 are the terminal cavities. On a top surface of the plug assembly 114 is the portion of the latch assembly 140 (see FIG. 17) including the resilient locking area 156.

FIGS. 20 and 21 illustrate the general dimensions of the housing 115 of the plug assembly 114. On overall height H4 is approximately 16.2 mm. A height H5 at the terminal cavities 110 is approximately 10.7 mm. The overall length L5 can be approximately 27.5 mm, while a length L6 at the terminal cavities is 19.5 mm. A width W6 of the assembly is approximately 21.6 mm.

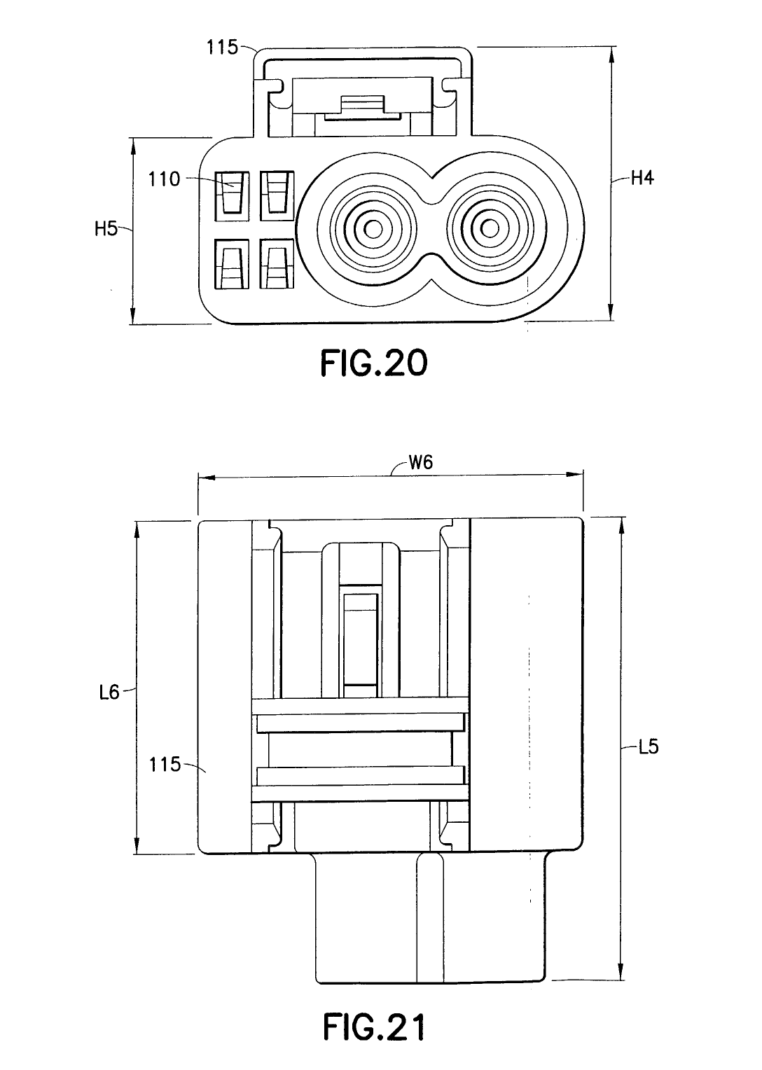

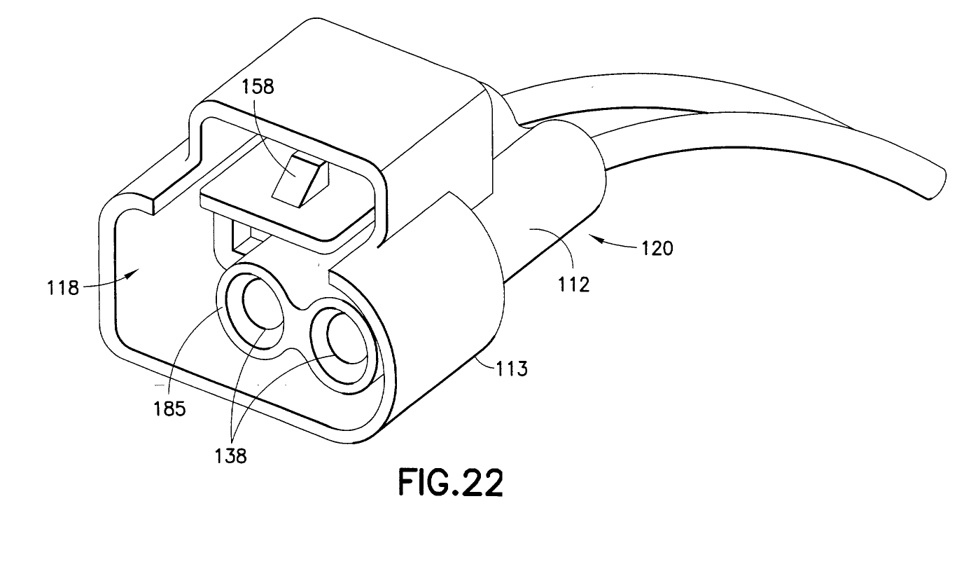

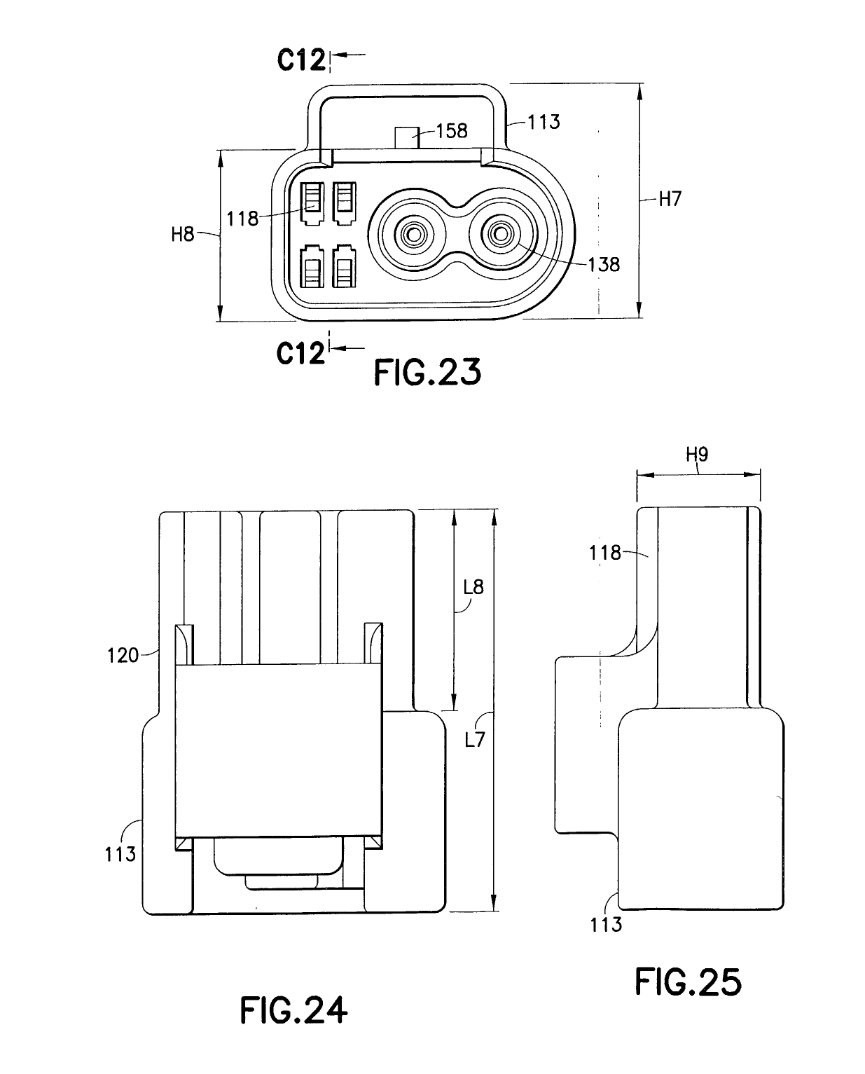

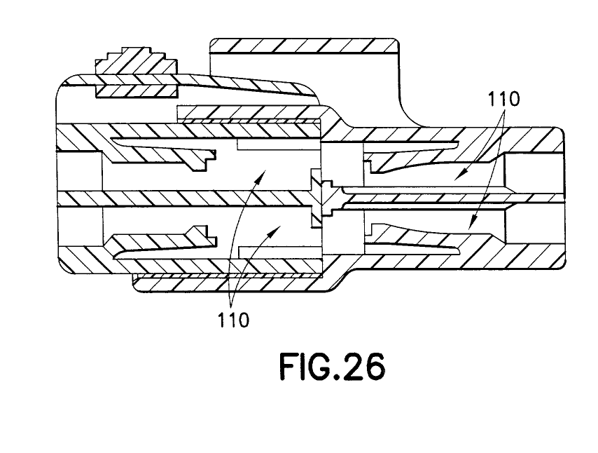

FIG. 22 is a perspective view of the socket portion 112 of the connector 100. As shown in FIG. 23, an overall height H7 of the socket housing 113 can be approximately 18.2 mm. A height H8 at the cavities 118 can be approximately 13.2 mm. As shown in FIG. 24 an overall length L7 is approximately 32 mm. A length L8 of the rear section 120 can be approximately 16.1 mm. The height H9 at the terminal cavities 118 can be approximately 10.0 mm, as shown in FIG. 25. FIG. 26 is a cross-sectional view of FIG. 23 taken along the line C12-C12 illustrating the interior section of the male and female terminal cavities. It will be understood that the connector assemblies are generally for automotive uses where small size is important. However, alternative uses and applications, are within the contemplation of the embodiments and any suitable dimensions can be used.

It should be understood that the foregoing description is only illustrative of the invention. Various alternatives and modifications can be devised by those skilled in the art without departing from the invention. Accordingly, the present invention is intended to embrace all such alternatives, modifications and variances which fall within the scope of the appended claims.

What is claimed is:

1. A multichannel fiber connector comprising:
a pair of mating connector parts, each including a body;
each mating connector part including an optical fiber coupling element for each respective channel, the optical fiber coupling element having an outer section and an inner section, the coupling element positioned on a first fiber receiving side having a first thread section and the coupling element on a second fiber receiving side having a second threaded section, the first and second threaded sections being directly in contact with and biting into the first and second fibers when the fibers are positioned in the respective optical coupling element; and
a latching assembly comprising a resilient locking arm on one connector part and a locking catch on the other connector part, the locking arm adapted to engage the locking catch when the connector parts are mated and secure the parts together.

2. The connector of claim 1 wherein the locking arm further comprises a web adapted to ride onto a first front ramp of the locking catch and engage a rear step surface of the catch, wherein the rear step surface of the catch to lock the mating connector parts.

3. The connector of claim 1 further comprising at least one barrel member in one connector part, the barrel member being adapted to be received in a complimentary barrel receiving member of the other connector part, wherein when the barrel member is received in the barrel receiving member an end of the first fiber is brought into close alignment with an end of the second fiber.

4. The connector of claim 1 wherein the resilient locking arm further comprises a rear surface adapted to be skewed from a substantially horizontal plane when the mating connector parts are not properly aligned and coupled.

5. The connector of claim 1 wherein the mating connector parts include a socket and a plug, the socket including a tip portion for each optical fiber element adapted to received a respective fiber element the plug element including a recess adapted to receive the tip and position the tip of the socket element along a perpendicular reference plane of a tip of the plug element, the tip of the plug element including a respective fiber element.

6. The connector of claim 1 further comprising integrated ferrules in each mating connector part.

7. A plastic optical fiber connector assembly comprising:
a plug assembly having at least one ferrule assembly integrated therein adapted to retain and position an end of a first fiber optic cable;
a socket assembly having at least one ferrule assembly integrated therein adapted to retain and position an end of a second fiber optic cable,
wherein when the plug assembly and socket assembly are mated, the end of the first cable and the end of the second cable are optically aligned; and
a connector position assurance device adapted to detect a partially connected assembly and securely latch the plug assembly and socket assembly together.

8. The connector assembly of claim 7 wherein the connector position assurance device comprises a latching arm and a locking catch, the latch arm adapted to ride up a ramp of the locking catch when the plug and socket assemblies are mated and engage a rear steep surface of the locking catch to lock the assemblies together.

9. The connector assembly of claim 8 wherein the latching arm is biased about a fulcrum and a downward force on a base end of the latching arm raises a web end of the latching arm to allow the plug and socket assemblies to be disconnected.

10. The connector assembly of claim 7 further comprising a plurality of 64 mm male and female terminal cavities and a latching assembly adapted to secure each mating connector part together, the latching assembly including a resilient locking arm.
